(19) United States
(12) Patent Application Publication
(10) Pub. No.: US 2025/0368199 A1
(43) Pub. Date: Dec. 4, 2025

(54) TRAVELING CONTROL APPARATUS

(71) Applicant: SUBARU CORPORATION, Tokyo (JP)

(72) Inventor: Yu WATANABE, Tokyo (JP)

(21) Appl. No.: 19/190,885

(22) Filed: Apr. 28, 2025

(30) Foreign Application Priority Data
May 31, 2024 (JP) 2024-089575

(51) Int. Cl. B60W 30/14

(52) U.S. Cl. CPC B60W 30/143; B60W 2552/15; B60W 2720/106

(57) ABSTRACT

A traveling control apparatus is configured to be applied to a vehicle and includes an information acquirer, a detector, and a vehicle speed processor. The information acquirer is configured to acquire traveling environment information on a surrounding environment around the vehicle. The surrounding environment includes an area ahead of the vehicle. The detector is configured to detect a gentle upward-gradient region of a short-distance road, based on the traveling environment information acquired by the information acquirer. The vehicle speed processor is configured to suppress, in the gentle upward-gradient region of the short-distance road, unnecessary acceleration and deceleration of the vehicle caused based on an integrated value of a deviation between an acceleration rate of the vehicle and a target acceleration rate.

### CROSS-REFERENCE TO RELATED APPLICATIONS

The present application claims priority from Japanese Patent Application No. 2024-089575 filed on May 31, 2024, the entire contents of which are hereby incorporated by reference.

### BACKGROUND

The disclosure relates to a traveling control apparatus.

A traveling control apparatus that performs cruise control of a vehicle is known. In the cruise control, the traveling control apparatus sets a target engine torque or a target rotation number of an input shaft of an automatic transmission, based on a difference between a vehicle speed set by a driver who drives the vehicle and a vehicle speed of the vehicle, in each operation cycle, to thereby causes the vehicle speed to converge at a target vehicle speed determined based on the vehicle speed set by the driver.

In such cruise control, when entering a road with a large traveling load, such as an uphill slope, under the cruise control, the vehicle is decelerated. In this case, engine control is performed that increases an engine output by increasing a throttle valve opening to immediately bring the vehicle speed to the target vehicle speed, while transmission control is performed that increases the torque by shifting down a speed ratio to accelerate the vehicle. This prevents the vehicle from being further decelerated.

Japanese Unexamined Patent Application Publication (JP-A) No. 2021-129346, for example, discloses a control device as an example of the technique described above. The control device disclosed in JP-A No. 2021-129346 controls the operation of a driving motor that outputs a driving force for a vehicle. The control device is capable of executing a normal mode and a cruise control mode that are switchable. In the normal mode, the control device controls acceleration and deceleration of the vehicle in accordance with an acceleration-and-deceleration operation by a driver who drives the vehicle. In the cruise control mode, the control device maintains a vehicle speed of the vehicle at a target vehicle speed by controlling torque of the driving motor without being dependent on the acceleration-and-deceleration operation by the driver. If determining that the vehicle has entered either one of a flat road and an uphill slope from a downhill slope or that the vehicle has entered a downhill slope from either one of a flat road or an uphill slope during the execution of the cruise control mode, the control device performs an integrated-value adjustment process of adjusting an integrated value of a deviation between the vehicle speed and the target vehicle speed so as to reduce an absolute value of the integrated value of the deviation a deviation in integral control. This prevents the vehicle from exhibiting an unstable behavior due to a change in gradient of the traveling road during the execution of the cruise control mode.

### SUMMARY

An aspect of the disclosure provides a traveling control apparatus configured to be applied to a vehicle. The traveling control apparatus includes an information acquirer, a detector, and a vehicle speed processor. The information acquirer is configured to acquire traveling environment information on a surrounding environment around the vehicle. The surrounding environment includes an area ahead of the vehicle. The detector is configured to detect a gentle upward-gradient region of a short-distance road, based on the traveling environment information acquired by the information acquirer. The vehicle speed processor is configured to suppress, in the gentle upward-gradient region of the short-distance road, unnecessary acceleration and deceleration of the vehicle caused based on an integrated value of a deviation between an acceleration rate of the vehicle and a target acceleration rate.

An aspect of the disclosure provides a traveling control apparatus configured to be applied to a vehicle. The traveling control apparatus includes circuitry configured to: acquire traveling environment information on a surrounding environment, including an area ahead of the vehicle, around the vehicle; detect a gentle upward-gradient region of a short-distance road, based on the traveling environment information; and suppress, in the gentle upward-gradient region of the short-distance road, unnecessary acceleration and deceleration of the vehicle caused based on an integrated value of a deviation between an acceleration rate of the vehicle and a target acceleration rate.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram illustrating an exemplary configuration of a traveling control apparatus according to one example embodiment of the disclosure.

FIG. 2 is a block diagram illustrating an exemplary configuration of a traveling electronic control unit illustrated in FIG. 1.

FIG. 3 is a flowchart of an exemplary process to be performed by the traveling control apparatus illustrated in FIG. 1.

FIG. 4 is a diagram schematically illustrating the process to be performed by the traveling control apparatus illustrated in FIG. 1.

FIG. 5 is a block diagram illustrating an exemplary configuration of a traveling control apparatus according to one example embodiment of the disclosure.

FIG. 6 is a block diagram illustrating an exemplary configuration of a traveling electronic control unit illustrated in FIG. 5.

FIG. 7 is a flowchart of an exemplary process to be performed by the traveling control apparatus illustrated in FIG. 5.

FIG. 8 is a diagram schematically illustrating the process to be performed by the traveling control apparatus illustrated in FIG. 5.

FIG. 9 is a block diagram illustrating a traveling control apparatus according to one example embodiment of the disclosure.

FIG. 10 is a block diagram illustrating an exemplary configuration of a traveling electronic control unit illustrated in FIG. 9.

FIG. 11 is a flowchart of an exemplary process to be performed by the traveling control apparatus illustrated in FIG. 9.

FIG. 12 is a diagram schematically illustrating the process to be performed by the traveling control apparatus illustrated in FIG. 9.

### DETAILED DESCRIPTION

JP-A No. 2021-129346 discloses a control device designed to prevent a vehicle from exhibiting an unstable behavior due to a change in gradient of a traveling road during execution of a cruise control mode. If determining that the vehicle has entered either one of a flat road and an uphill slope from a downhill slope or that the vehicle has entered a downhill slope from either one of a flat road and an uphill slope during the execution of the cruise control mode, the control device performs an integrated-value adjustment process of adjusting an integrated value of a deviation between a vehicle speed and a target vehicle speed so as to reduce an absolute value of the integrated value of the deviation in integral control. However, the control device disclosed in JP-A No. 2021-129346 is not designed to suppress unnecessary acceleration of the vehicle that arouses an unwanted feeling of fear of an occupant of the vehicle before the vehicle enters a downhill slope from an uphill slope. JP-A No. 2021-129346 fails to disclose or suggest any measure to suppress unnecessary acceleration of the vehicle before the vehicle enters a downhill slope from an uphill slope.

Meanwhile, in the cruise control, gradient estimation is performed by acceleration sensors respectively disposed on front and rear portions of the vehicle to estimate the gradient of the traveling road.

The gradient estimation involves the use of a primary delay filter to remove disturbance noise. Due to the presence of the primary delay filter, the gradient estimated by the gradient estimation corresponds to a previous gradient prior to an actual gradient on which the vehicle is currently traveling. For example, even though the vehicle is traveling on an uphill slope, it can be estimated that the vehicle is traveling on a flat road, and thus the vehicle can be decelerated. Further, even though the vehicle is traveling in a crest area of an uphill slope, it can be estimated that the vehicle is traveling on an uphill slope, and thus the vehicle can be accelerated.

In the cruise control, acceleration feedback offset control is further performed to offset a deviation between a target acceleration rate and an actual acceleration rate of the vehicle generated by a disturbance during traveling under the cruise control.

The acceleration feedback offset control brings the acceleration rate of the vehicle to the target acceleration rate; however, such a feedback offset is an integral term of the integral control that is slow in change and therefore can cause excess acceleration in a location where the vehicle is to be decelerated, such as the crest area of an uphill slope.

The acceleration feedback offset control can thus arouse an unwanted feeling of fear of an occupant of the vehicle against excess acceleration in a location, such as the crest area of the uphill slope, where the occupant is unable to take a view of the road ahead.

It is desirable to provide a traveling control apparatus that achieves safety travel without arousing an unwanted feeling of fear of the occupant.

### EXAMPLE EMBODIMENTS

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

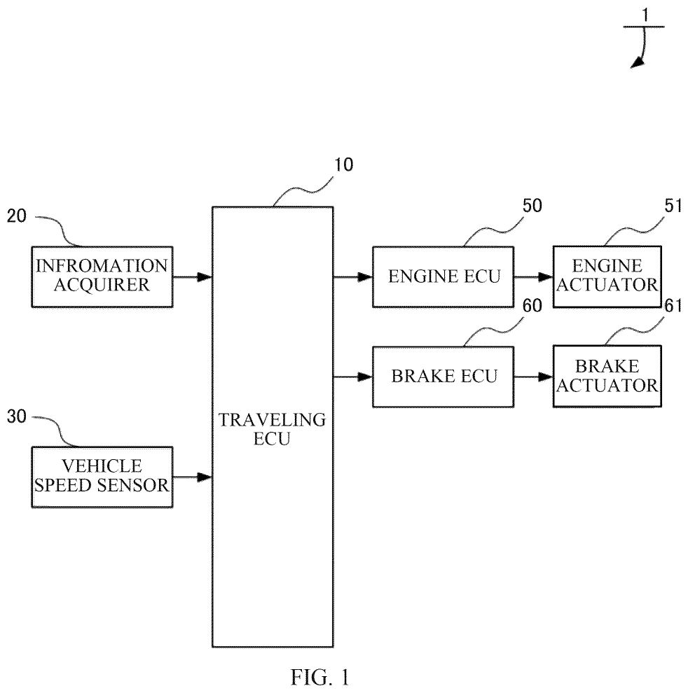

A traveling control apparatus according to an example embodiment will now be described with reference to FIG. 1 to FIG. 12.

### First Example Embodiment

A traveling control apparatus 1 according to the present example embodiment will now be described with reference to FIGS. 1 to 4.

### <Exemplary Configuration of Traveling Control Apparatus 1>

As illustrated in FIG. 1, the traveling control apparatus 1 according to the present example embodiment may include a traveling electronic control unit (ECU) 10, an information acquirer 20, a vehicle speed sensor 30, an engine ECU 50, an engine actuator 51, a brake ECU 60, and a brake actuator 61.

The traveling ECU 10 controls traveling of a vehicle.

Further, the traveling ECU 10 suppresses unnecessary acceleration of the vehicle in a gentle upward-gradient region of an uphill slope of a short-distance road.

The term “short-distance road” as used herein may refer to, for example but not limited to, a hill, such as an overbridge, having a series of short uphill slopes and short downhill slopes each having a length of several ten to hundred meters.

The gentle upward-gradient region may be defined in accordance with a distance from the vehicle to the crest area of the short-distance road acquired by the information acquirer 20 to be described later.

In the present example embodiment, the traveling ECU 10 may perform control of clearing a component of integral control performed by an acceleration processor 12 to be described later in the gentle upward-gradient region of the short-distance road.

In some embodiments, the traveling ECU 10 may perform the control of clearing the component of the integral control performed by the acceleration processor 12 to be described later when a difference between an acceleration rate of the vehicle and a target acceleration rate becomes less than or equal to zero.

The information acquirer 20, the vehicle speed sensor 30, the engine ECU 50, and the brake ECU 60 that are to be described later may be coupled to the traveling ECU 10.

Among these elements, the information acquirer 20 and the vehicle speed sensor 30 may be directly coupled to the traveling ECU 10.

Further, the engine ECU 50 and the brake ECU 60 may transmit information to and receive information from the traveling ECU 10 via a control area network (CAN).

The information acquirer 20 acquires traveling environment information on a surrounding environment, including an area ahead of the vehicle, around the vehicle.

The information acquirer 20 may include, for example but not limited to, an imaging device such as a charge coupled device (CCD) or a CMOS image sensor (CIS). The information acquirer 20 may output an image (a moving image or a static image) of the surrounding environment, including the area ahead of the vehicle, captured by the imaging device.

In some embodiments, the information acquirer 20 may include both an optical imaging device and a near-infrared imaging device to acquire the traveling environment information on the surrounding environment, including the area ahead of the vehicle, any time day or night.

The vehicle speed sensor 30 may detect a traveling speed of the vehicle (vehicle speed) and output a signal indicating the vehicle speed to the traveling ECU 10.

The engine ECU 50 may be coupled to the engine actuator 51.

The engine actuator 51 may change an operation state of an internal combustion engine.

In the present example embodiment, the internal combustion engine may be a gasoline-fuel-injection, spark-ignition, muti-cylinder engine provided with a throttle valve that adjusts an intake air amount.

A description of the present example embodiment is given by the way of example where a vehicle includes an internal combustion engine; however, the description is also applicable to an electric vehicle or a hybrid vehicle, for example.

The brake ECU 60 may be coupled to the brake actuator 61.

The brake actuator 61 may be disposed in a hydraulic circuit provided between a master cylinder that pressurizes hydraulic fluid in accordance with a brake pedal pressure and a friction brake mechanism provided for each of a right-front wheel, a left-front wheel, a right-rear wheel, and a left-rear wheel.

### <Exemplary Configuration of Traveling ECU 10>

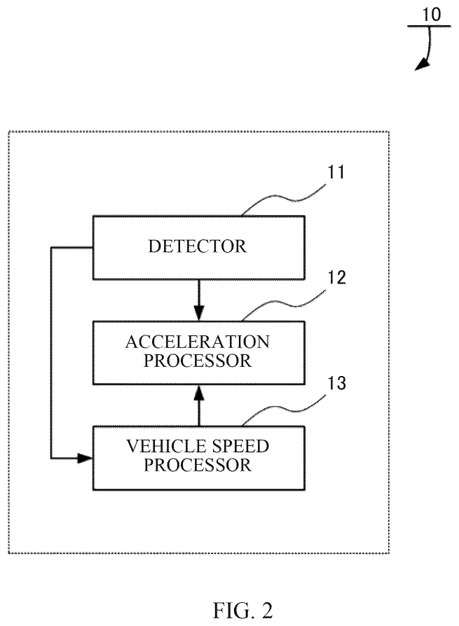

As illustrated in FIG. 2, the traveling ECU 10 according to the present example embodiment may include a detector 11, the acceleration processor 12, and a vehicle speed processor 13.

The detector 11 detects the short-distance road such as an overbridge, by analyzing the traveling environment information acquired by the information acquirer 20.

Further, the detector 11 may calculate the distance from the vehicle to a crest area of the short-distance road by analyzing the traveling environment information acquired by the information acquirer 20.

The acceleration processor 12 may control an acceleration rate of the vehicle by performing the integral control that is based on an integrated value of a deviation between the acceleration rate of the vehicle and the target acceleration rate.

In an example where the vehicle is an electric vehicle, the acceleration processor 12 may calculate a torque command value that brings the vehicle speed of the vehicle to the target vehicle speed, and perform control that brings the torque of a driving motor to the torque command value.

In some embodiments, the acceleration processor 12 may control the torque of the driving motor by performing feedforward control that is based on the acceleration rate of the vehicle, and feedback control (e.g., PID control) that is based on the deviation between the acceleration rate of the vehicle and the target acceleration rate, and calculate the torque command value which is to be sent to the driving motor as a command indicating the controlled torque.

The torque command value may include a feedforward control component that is based on the acceleration rate of the vehicle, a proportional control component that is based on the magnitude of the deviation between the acceleration rate of the vehicle and the target acceleration rate, a differential and integral control component that is based on the magnitude of change in the deviation, and an integral control component that is based on the integrated value of the deviation. Among these components, the integral control component based on the magnitude of change in the deviation may have a characteristic of being slow in change.

The vehicle speed processor 13 suppresses unnecessary acceleration of the vehicle in the gentle upward-gradient region of the uphill slope of the short-distance road.

In the present example embodiment, the vehicle speed processor 13 may perform the control of clearing the component in the integral control performed by the acceleration processor 12, in the gentle upward-gradient region of the short-distance road.

In some embodiments, the vehicle speed processor 13 may perform the control of clearing the component in the integral control performed by the acceleration processor 12 when the difference between the acceleration rate of the vehicle and the target acceleration rate becomes less than or equal to zero.

### <Exemplary Process to be Performed by Traveling Control Apparatus 1>

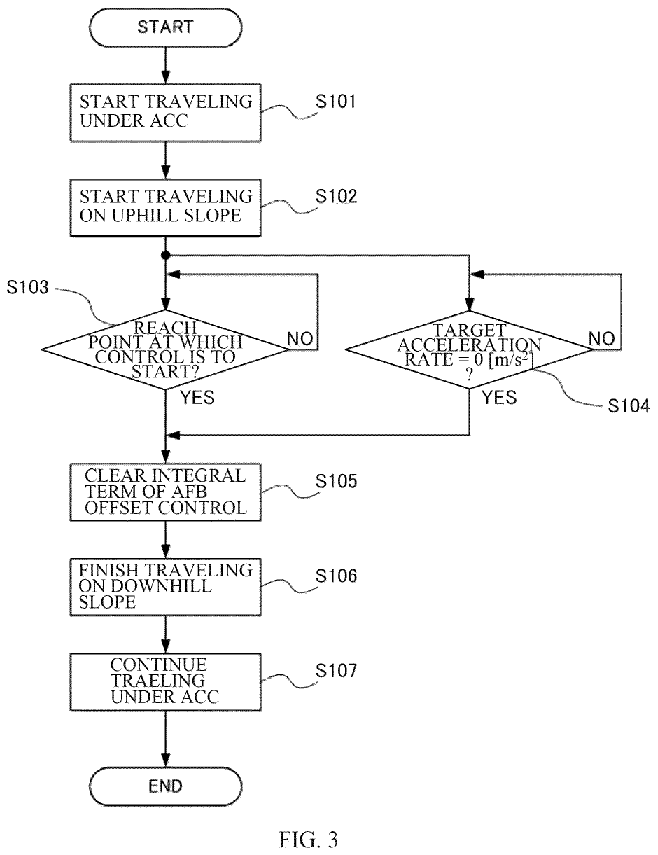

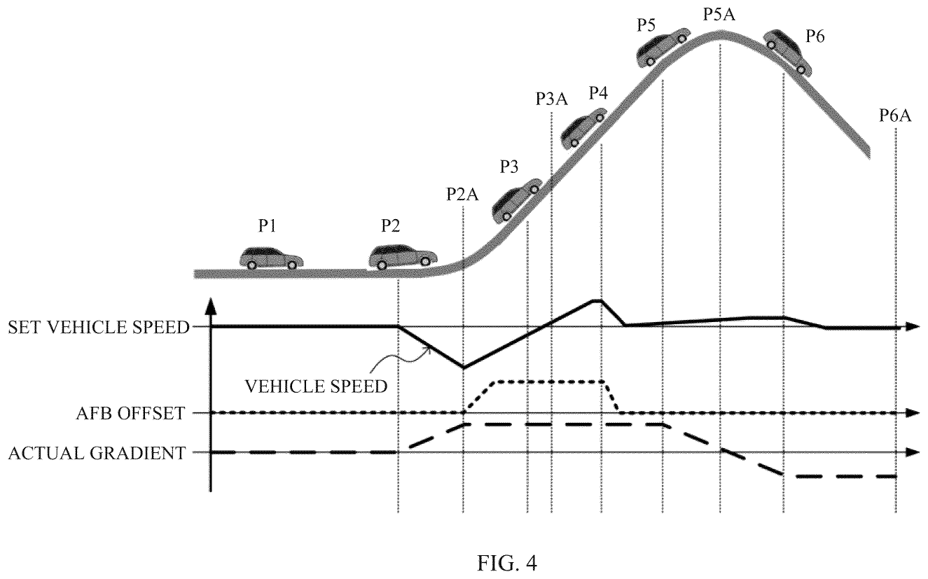

An exemplary process to be performed by the traveling control apparatus 1 according to the present example embodiment will now be described with reference to FIGS. 3 and 4.

The vehicle may start traveling under adaptive cruise control (ACC) (Step S101).

For example, the traveling control apparatus 1 may cause the vehicle to start traveling at a set vehicle speed of 50 km/h under the ACC at a point P1 in FIG. 4.

The vehicle may start traveling on an uphill slope at a point P2 in FIG. 4 (Step S102).

At this time, the vehicle speed of the vehicle may be decreased to, for example, about 49.5 km/h due to an influence of an upward gradient.

Thereafter, at a point P2A in FIG. 4, for example, an acceleration feedback (AFB) offset value may start increasing; however, the timing of start of increase in the AFB offset value may be slightly delayed relative to the timing of start of increase in an actual gradient, which further decreases the vehicle speed of the vehicle to, for example, about 47 km/h due to the influence of the upward gradient.

Thereafter, at a point P3 in FIG. 4, the vehicle speed of the vehicle may be increased to about 49 km/h, which is close to the set vehicle speed, due to the AFB offset value increased by the AFB offset control performed by the acceleration processor 12 based on the deviation between the acceleration rate of the vehicle and the target acceleration rate.

Thereafter, at a point P3A in FIG. 4, for example, the increased AFB offset value may be prevented from immediately decreasing even when the vehicle speed of the vehicle exceeds the set vehicle speed, and the vehicle speed may be increased to about 51 km/h by the AFB offset control performed by the acceleration processor 12 based on the deviation between the acceleration rate of the vehicle and the target acceleration rate.

At a point P4 in FIG. 4, the increased AFB offset value may be still prevented from immediately decreasing even when the vehicle speed of the vehicle exceeds the set vehicle speed, and the vehicle speed may be increased to about 52 km/h by the AFB offset control performed by the acceleration processor 12 based on the deviation between the acceleration rate of the vehicle and the target acceleration rate.

The acceleration processor 12 may determine whether the detector 11 has detected the gentle upward-gradient region of the short-distance road, such as an overbridge, based on the traveling environment information acquired by the information acquirer 20 (Step S103).

In some embodiments, the acceleration processor 12 may determine whether the detector 11 has detected the crest area of the short-distance road, such as an overbridge, based on the image data on the area ahead of the vehicle acquired by the information acquirer 20, and whether the distance from a current position (the point P4 in FIG. 4) of the vehicle to the crest area of the short-distance road, such as an overbridge, is equal to a predetermined distance, that is, whether the current position of the vehicle is a point at which the control is to start.

In some embodiments, the predetermined distance may be 3 meters or greater and 15 meters or less, taking into consideration the gradient of the short-distance road, such as an overbridge.

If the acceleration processor 12 determines that the detector 11 has not detected the gentle upward-gradient region of the short-distance road, such as an overbridge, based on the traveling environment information acquired by the information acquirer 20 (Step S103: NO), the process may shift to a stand-by mode.

If the acceleration processor 12 determines that the detector 11 has detected the gentle upward-gradient region of the short-distance road, such as an overbridge, based on the traveling environment information acquired by the information acquirer 20 (Step S103: YES), the vehicle speed processor 13 may perform the control of clearing the integral term of the AFB offset (Step S105).

Since the AFB offset value is cleared by the control, the vehicle speed of the vehicle may be decreased from about 52 km/h set at the point P4 in FIG. 4 to the set vehicle speed (e.g., 50 km/h) at a point P5 in FIG. 4, for example.

Thereafter, at a point P5A in FIG. 4, the vehicle may reach the gentle upward-gradient region near the crest area of the uphill slope, and the vehicle speed may be increased to about 50.5 km/h that is slightly greater than the set vehicle speed.

After the vehicle starts traveling on the uphill slope, the acceleration processor 12 may determine whether the target acceleration rate is 0 [m/s²] (Step S104).

If the acceleration processor 12 determines that the target acceleration rate is not 0 [m/s²] (Step S104: NO), the process may shift to the stand-by mode.

If the acceleration processor 12 determines that the target acceleration rate is 0 [m/s²] (Step S104: YES), the vehicle speed processor 13 may perform the control of clearing the integral term of the AFB offset (Step S105).

In this case also, the vehicle speed of the vehicle may be decreased from 52 km/h set at the point P4 in FIGS. 4 to 50 km/h at the point P5 in FIG. 4, for example. At a point P6 in FIG. 4, the vehicle speed may be increased to 51 km/h due to an influence of a downward gradient; however, the AFB offset value may be set at a negative value to prevent the vehicle speed from increasing excessively.

Thereafter, at a point P6A in FIG. 4, the vehicle speed may be settled at the set vehicle speed by the AFB offset value set at the negative value, and thereafter the AFB offset value may be increased toward zero.

If it is determined by the detector 11 that the vehicle has finished traveling on the downhill slope, based on the image data on the area ahead of the vehicle acquired from the information acquirer 20 (Step S106), the vehicle speed processor 13 may end the process while continuing the traveling under the ACC (Step S107).

### <Workings and Effects>

As described above, the traveling control apparatus 1 according to the present example embodiment may include the information acquirer 20, the detector 11, the acceleration processor 12, and the vehicle speed processor 13. The information acquirer 20 acquires the traveling environment information on the surrounding environment around the vehicle. The surrounding environment includes the area ahead of the vehicle. The detector 11 detects the gentle upward-gradient region of the short-distance road, such as an overbridge, based on the traveling environment information acquired by the information acquirer 20. The acceleration processor 12 may control the acceleration rate of the vehicle by performing the integral control that is based on the integrated value of the deviation between the acceleration rate of the vehicle and the target acceleration rate. The vehicle speed processor 13 suppresses, in the gentle upward-gradient region of the short-distance road, unnecessary acceleration and deceleration of the vehicle caused based on the integrated value of the deviation between the acceleration rate of the vehicle and the target acceleration rate.

That is, the detector 11 may detect, based on the traveling environment information acquired by the information acquirer 20, the gentle upward-gradient region of the short-distance road, such as an overbridge, and the vehicle speed processor 13 may send the acceleration processor 12 a control signal that suppresses, in the gentle upward-gradient region of the short-distance road, unnecessary acceleration and deceleration caused based on the integrated value of the deviation between the acceleration rate of the vehicle and the target acceleration rate.

It is therefore possible to achieve safety travel without arousing an unwanted feeling of fear of the occupant of the vehicle.

Further, the vehicle speed processor 13 of the traveling control apparatus 1 according to the present example embodiment may perform the control of clearing the component of the integral control performed by the acceleration processor 12, in the gentle upward-gradient region of the short-distance road.

The feedback offset that offsets the deviation between the target acceleration rate and the acceleration rate of the vehicle may be an integral term of the integral control that is slow in change.

Such a feedback offset can cause excess acceleration in a location where the vehicle is to be decelerated, such as a crest area of an uphill slope.

To address such a problem, the vehicle speed processor 13 according to the present example embodiment is configured to suppress, in the gentle upward-gradient region located before the crest area of the short-distance road, unnecessary acceleration of the vehicle caused based on the integrated value of the deviation between the acceleration rate of the vehicle and the target acceleration rate, by performing the control of clearing the component of the integral control performed by the acceleration processor 12.

Note that the control described above may be effective for a steep short-distance road including a short uphill slope.

Further, when the difference between the acceleration rate of the vehicle and the target acceleration rate becomes less than or equal to zero, the vehicle speed processor 13 of the traveling control apparatus 1 according to the present example embodiment may perform the control of clearing the component of the integral control performed by the acceleration processor 12.

For example, in the short-distance road including a relatively long uphill slope, the difference between the acceleration rate of the vehicle and the target acceleration rate can become less than or equal to zero before the vehicle reaches the crest area of the short-distance road where the component of the integral control performed by the acceleration processor 12 is to be cleared, as described above.

It is not necessary to accelerate the vehicle when the difference between the acceleration rate of the vehicle and the target acceleration rate is less than or equal to zero; however, the feedback offset, which is the integral term of the integral control being slow in change, can accelerate the vehicle.

In such a case, it is possible to suppress unnecessary acceleration cased based on the integrated value of the deviation between the acceleration rate of the vehicle and the target acceleration rate by performing the control of clearing the component of the integral control performed by the acceleration processor 12 even though the vehicle has not yet reached the crest area of the short-distance road where the component of the integral control performed by the acceleration processor 12 is to be cleared.

### Second Example Embodiment

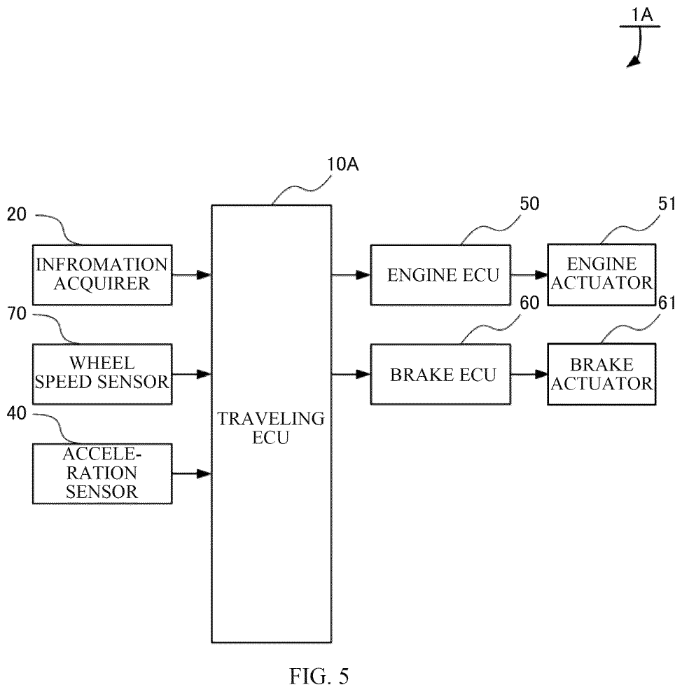

A traveling control apparatus 1A according to the present example embodiment will now be described with reference to FIGS. 5 to 8.

### <Exemplary Configuration of Traveling Control Apparatus 1A>

As illustrated in FIG. 5, the traveling control apparatus 1A according to the present example embodiment may include a traveling electronic control unit (ECU) 10A, the information acquirer 20, an acceleration sensor 40, the engine ECU 50, the engine actuator 51, the brake ECU 60, the brake actuator 61, and a wheel speed sensor 70.

Note that elements having the same configurations as those in the first example embodiment are denoted with the same reference numerals as those in the first example embodiment to omit a detailed description thereof.

The traveling ECU 10A controls traveling of the vehicle. Further, the traveling ECU 10A suppresses unnecessary acceleration of the vehicle in the gentle upward-gradient region of the short-distance road.

In the present example embodiment, the traveling ECU 10A may detect, based on the traveling environment information acquired by the information acquirer 20, the gentle upward-gradient region of the short-distance road, such as an overbridge.

In the present example embodiment, the traveling ECU 10A may perform control of sequentially decreasing the value of a primary delay time constant used at an estimator 14 to be described later, in accordance with the distance between the vehicle and the crest area of the short-distance road detected by the detector 11, in the gentle upward-gradient region of the short-distance road.

To end the control, the control of sequentially increasing (returning) the value of the primary delay time constant used at the estimator 14 to be described later, as the downward gradient of the short-distance road becomes gentler.

The acceleration sensor 40 may include a pair of sensors disposed along a longitudinal direction of the vehicle. The acceleration sensor 40 may output a voltage in accordance with an acceleration rate in the longitudinal direction of the vehicle.

Herein, the acceleration rate sensed by the acceleration sensor 40 in the longitudinal direction of the vehicle may refer to a sum total of an acceleration rate generated by accelerated motion of the vehicle in the longitudinal direction and an acceleration rate generated by the gravity caused by an inclination of the vehicle in the longitudinal direction.

The acceleration sensor 40 may be a known acceleration sensor of any type, such as an electrostatic acceleration sensor, a piezoelectric acceleration sensor, or a semiconductor strain-gauge acceleration sensor.

The wheel speed sensor 70 may detect a rotation speed of each wheel of the vehicle as a signal.

In some embodiments, the wheel speed sensor 70 may include a gear-shaped rotor provided at a rotational part, such as a drive shaft, an axle hub, or a brake drum, and sensors placed at intervals around the rotor. The sensors may each include a coil and a magnetic pole.

When the rotor rotates, a magnetic flux passing through the coil may change to generate an alternating voltage, which enables detection of a rotation speed.

### <Exemplary Configuration of Traveling ECU 10A>

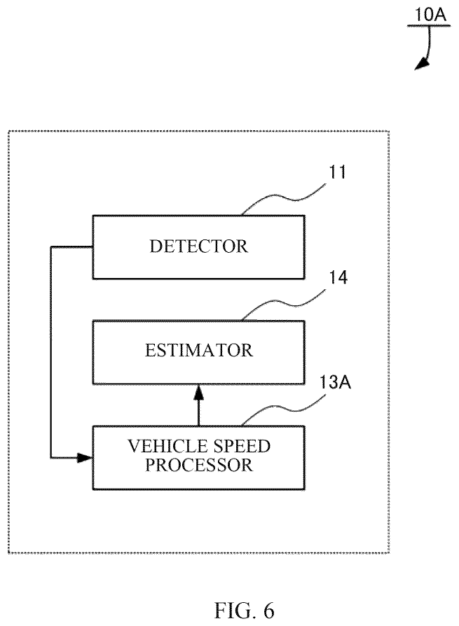

As illustrated in FIG. 6, the traveling ECU 10A according to the present example embodiment may include the detector 11, a vehicle speed processor 13A, and the estimator 14.

Note that elements having the same configurations as those in the first example embodiment are denoted with the same reference numerals as those in the first example embodiment to omit a detailed description thereof.

The vehicle speed processor 13A may perform the control of sequentially decreasing the value of the primary delay time constant used at the estimator 14 to be described later, in accordance with the distance between the vehicle and the crest area of the short-distance road detected by the detector 11, in the gentle upward-gradient region of the short-distance road.

The estimator 14 may estimate an upward gradient of the short-distance road by performing filter processing of sensor outputs from the acceleration sensors 40 respectively disposed on the front and rear portions of the vehicle, using the primary delay time constant.

When the vehicle is stopped, for example, the estimator 14 may set a road surface gradient value, based on the sensor data detected by the acceleration sensors 40 respectively disposed on the front and rear portions of the vehicle.

During traveling of the vehicle, the estimator 14 may calculate a wheel acceleration rate by differentiating a wheel speed of a driving wheel detected by each wheel speed sensor 70 with respect to time, based on the sensor data received from the sensors respectively disposed on the front and rear portions of the vehicle. The estimator 14 may subtract an average value of the wheel speeds from the sensor data received from the sensors disposed on the front and rear portions of the vehicle (i.e., performs correction of the sensor data) to remove an acceleration component, and thereafter perform the filter processing using the primary delay time constant to estimate the road surface gradient value.

### <Exemplary Process to be Performed by Traveling Control Apparatus 1A>

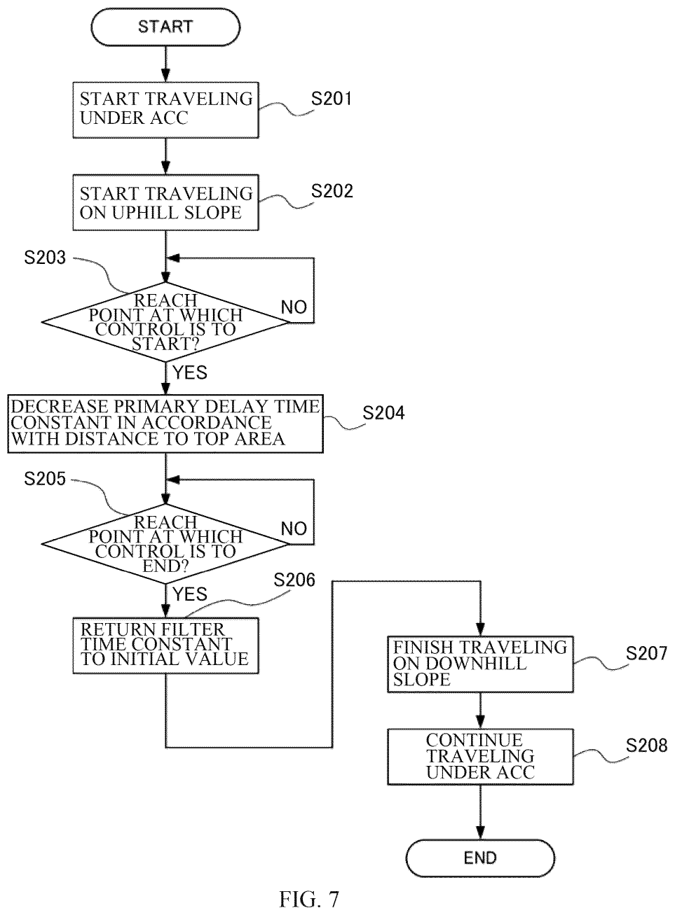

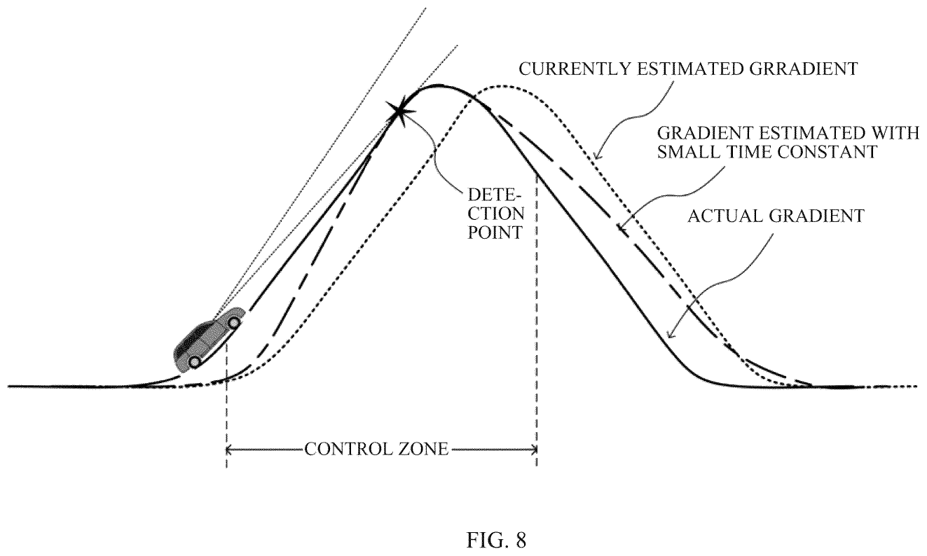

An exemplary process to be performed by the traveling control apparatus 1A according to the present example embodiment will now be described with reference to FIGS. 7 and 8.

The vehicle may start traveling under adaptive cruise control (ACC) (Step S201).

Thereafter, the vehicle may start traveling on the uphill slope (Step S102).

The vehicle speed processor 13A may determine whether the detector 11 has detected, based on the traveling environment information acquired by the information acquirer 20, whether the vehicle has reached the gentle upward-gradient region of the short-distance road, such as an overbridge, that is, a point at which the control is to start (Step S203).

In some embodiments, the vehicle speed processor 13A may determine whether the detector 11 has detected the crest area of the short-distance road, such as an overbridge (e.g., a detection point illustrated in FIG. 8), based on the image data on the area ahead of the vehicle acquired by the information acquirer 20.

If the vehicle speed processor 13A determines that the detector 11 has not yet detected the crest area of the short-distance road, such as an overbridge, based on the image data on the area ahead of the vehicle acquired by the information acquirer 20 (Step S203: NO), the process may shift to the stand-by mode.

If the vehicle speed processor 13A determines that the detector 11 has detected the crest area of the short-distance road, such as an overbridge, based on the image data on the area ahead of the vehicle acquired from the information acquirer 20 (Step S203: YES), the vehicle speed processor 13A may perform the control of decreasing the primary delay time constant in accordance with the distance to the crest area of the short-distance road, such as an overbridge (Step S204).

Such control brings the currently estimated gradient (indicated by a dotted line in FIG. 8) deviated from an actual gradient (indicated by a solid line in FIG. 8) to the actual gradient, as illustrated in FIG. 8.

Thereafter, the vehicle speed processor 13A may determine whether a predetermined time has elapsed after the vehicle has reached the crest area of the short-distance road, such as an overbridge, that is, whether the vehicle has reached a point at which the control is to end (Step S205).

In some embodiments, the predetermined time may be 10 seconds.

The point at which the control is to end may be determined as follows: A point at which a downhill slope ends to merge with a flat road may be detected by a camera, and, if the distance to the end point of the downhill slope is within a predetermined range, the end point of the downhill slope may be set as the point at which the control is to end.

In some embodiments, the point where the downhill slope ends to merge with the flat road may be detected by performing a comparison with an object serving as a horizontal or vertical reference, such as a road sign or a house located on a road side.

If the vehicle speed processor 13A determines that the vehicle has not yet reached the point at which the control is to end (Step S205: NO), the process may shift to the stand-by mode.

If the vehicle speed processor 13A determines that the vehicle has reached the point at which the control is to end (Step S205: YES), the primary delay time constant may be returned to an initial value (Step S206).

If it is determined by the detector 11 that the vehicle has finished traveling on the downhill slope, based on the image data on the area ahead of the vehicle acquired by the information acquirer 20 (Step S207), the vehicle speed processor 13A may end the process while continuing the traveling under the ACC (Step S208).

### <Workings and Effects>

As described above, the traveling control apparatus 1A according to the present example embodiment may further includes the estimator 14 that estimates the upward gradient of the short-distance road by performing the filter processing of the sensor outputs from the acceleration sensors 40 respectively disposed on the front and rear portions of the vehicle, using the primary delay time constant. The vehicle speed processor 13A may sequentially decrease the value of the primary delay time constant in accordance with the distance between the vehicle and the crest area of the short-distance road detected by the detector 11, in the gentle upward-gradient region of the short-distance road.

That is, the vehicle speed processor 13A may sequentially decrease the value of the primary delay time constant in accordance with the distance between the vehicle and the crest area of the short-distance road detected by the detector 11, in the gentle upward-gradient region of the short-distance road, to thereby bring the gradient estimated by the estimator 14 closer to the actual gradient.

### Third Example Embodiment

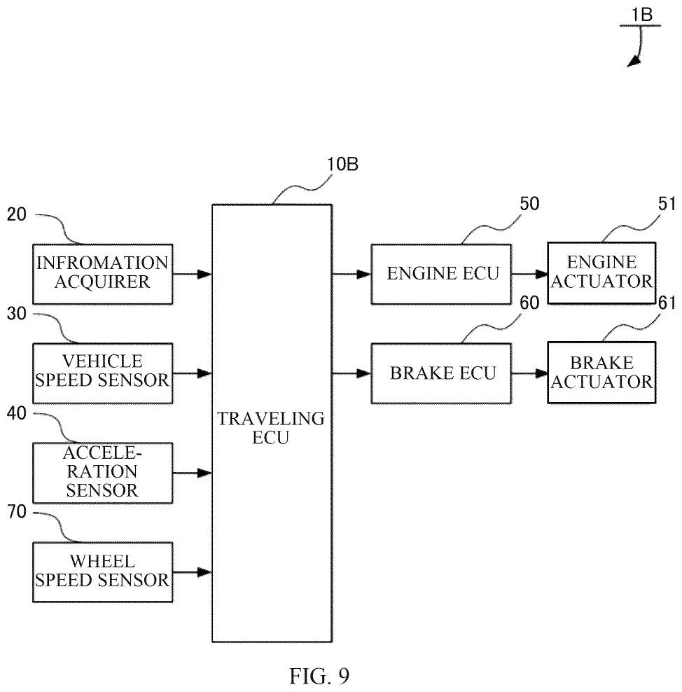

A traveling control apparatus 1B according to the present example embodiment will now be described with reference to FIGS. 9 to 12.

### <Exemplary Configuration of Traveling Control Apparatus 1B>

As illustrated in FIG. 9, the traveling control apparatus 1B according to the present example embodiment may include a traveling electric control unit (ECU) 10B, the information acquirer 20, the vehicle speed sensor 30, the acceleration sensor 40, the engine ECU 50, the engine actuator 51, the brake ECU 60, the brake actuator 61, and the wheel speed sensor 70.

Note that elements having the same configurations as those in the first and second example embodiments are denoted with the same reference numerals as those in the first and second example embodiments to omit a detailed description thereof.

The traveling ECU 10B controls traveling of the vehicle. Further, the traveling ECU 10B suppresses unnecessary acceleration of the vehicle in the gentle upward-gradient region of the short-distance road.

In the present example embodiment, the traveling ECU 10B may detect, based on the traveling environment information acquired by the information acquirer 20, the gentle upward-gradient region of the short-distance road, such as an overbridge.

In the present example embodiment, the traveling ECU 10B may perform the control of clearing the component of the integral control performed by the acceleration processor 12, in the gentle upward-gradient region of the short-distance road.

Further, when the difference between the acceleration rate of the vehicle and the target acceleration rate becomes less than or equal to zero, the traveling ECU 10B may perform the control of clearing the component of the integral control performed by the acceleration processor 12.

Further, in the present example embodiment, the traveling ECU 10B may perform the control of sequentially decreasing the value of the primary delay time constant used at the estimator 14 to be described later, in accordance with the distance between the vehicle and the crest area of the short-distance road detected by the detector 11, in the gentle upward-gradient region of the short-distance road.

### <Exemplary Configuration of Traveling ECU 10B>

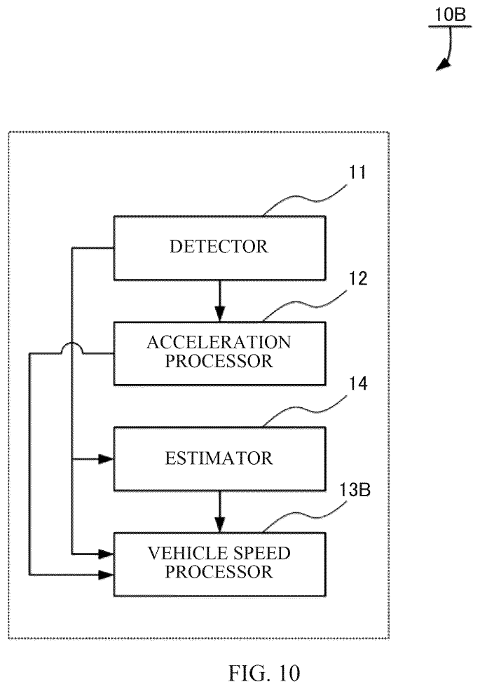

As illustrated in FIG. 10, the traveling ECU 10B according to the present example embodiment may include the detector 11, the acceleration processor 12, a vehicle speed processor 13B, and the estimator 14.

Note that elements having the same configurations as those in the first and second example embodiments are denoted with the same reference numerals as those in the first and second example embodiments to omit a detailed description thereof.

The vehicle speed processor 13B may perform the control of clearing the component of the integral control performed by the acceleration processor 12, in the gentle upward-gradient region of the short-distance road.

Further, in the present example embodiment, the vehicle speed processor 13B may perform the control of clearing the component of the integral control performed by the acceleration processor 12 when the difference between the acceleration rate of the vehicle and the target acceleration rate becomes less than or equal to zero.

The vehicle speed processor 13B may perform the control of sequentially decreasing the value of the primary delay time constant used at the estimator 14 to be described later, in accordance with the distance between the vehicle and the crest area of the short-distance road detected by the detector 11, in the gentle upward-gradient region of the short-distance road.

### <Exemplary Process to be Performed by Traveling Control Apparatus 1B>

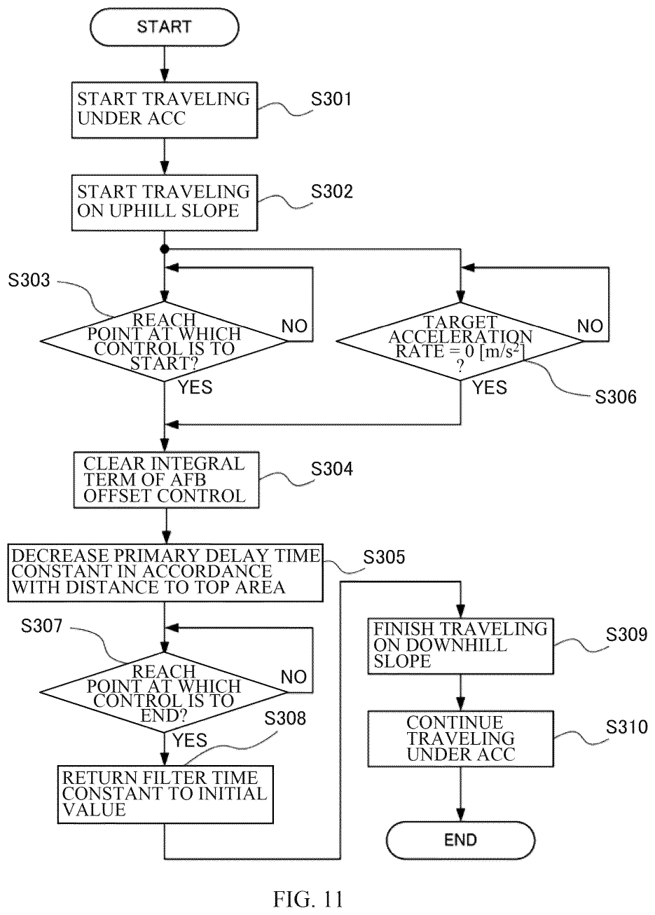

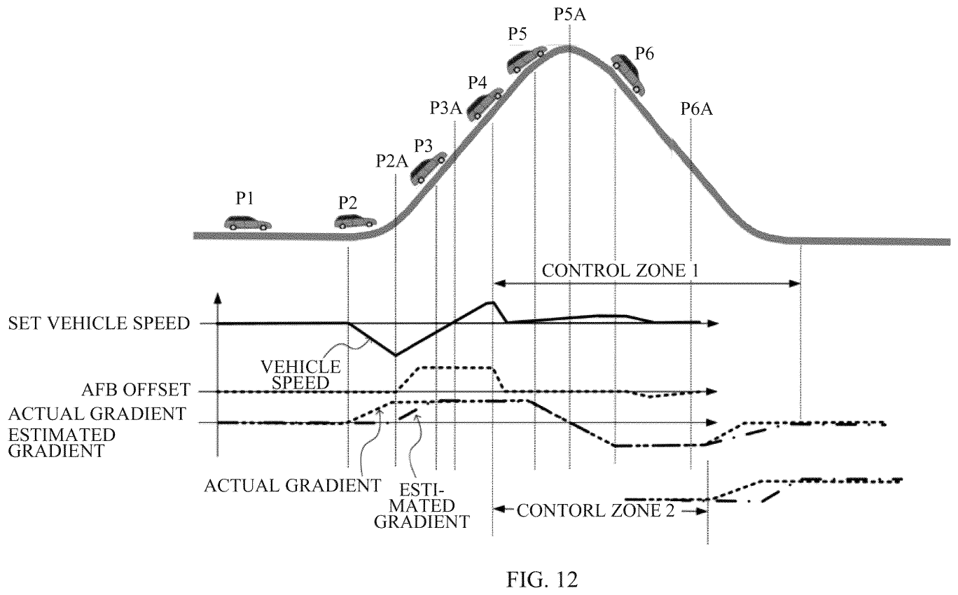

An exemplary process to be performed by the traveling control apparatus 1A according to the present example embodiment will now be described with reference to FIGS. 11 and 12.

The vehicle may start traveling under adaptive cruise control (ACC) (Step S301).

For example, the traveling control apparatus 1B may cause the vehicle to start traveling at a set vehicle speed of 50 km/h under the ACC at a point P1 in FIG. 12.

The vehicle may start traveling on an uphill slope at a point P2 in FIG. 12 (Step S302).

At this time, the vehicle speed of the vehicle may be decreased to, for example, about 49.5 km/h due to an influence of an upward gradient.

Thereafter, at a point P2A in FIG. 12, for example, the AFB offset value may start increasing; however, the timing of start of increase in the AFB offset value may be slightly delayed relative to the timing of start of increase in an actual gradient, which further decreases the vehicle speed of the vehicle to, for example, about 47 km/h due to the influence of the upward gradient.

Thereafter, at a point P3 in FIG. 12, the vehicle speed of the vehicle may be increased to about 49 km/h, which is close to the set vehicle speed, due to the AFB offset value increased by the AFB offset control performed by the acceleration processor 12 based on the deviation between the acceleration rate of the vehicle and the target acceleration rate.

Thereafter, at a point P3A in FIG. 12, for example, the AFB offset value may be maintained at an increased value even when the vehicle speed of the vehicle exceeds the set vehicle speed, and the vehicle speed of the vehicle may be increased to about 51 km/h by the AFB offset control performed by the acceleration processor 12 based on the deviation between the acceleration rate of the vehicle and the target acceleration rate.

At a point P4 in FIG. 12, the AFB offset value may still be maintained at an increased value even when the vehicle speed of the vehicle exceeds the vehicle speed. In addition, owing to the delay in estimating the gradient, the vehicle speed of the vehicle may be increased to about 52 km/h by the AFB offset control performed by the acceleration processor 12 based on the deviation between the acceleration rate of the vehicle and the target acceleration rate.

The acceleration processor 12 may determine whether the detector 11 has detected the gentle upward-gradient region of the short-distance road, such as an overbridge, based on the traveling environment information acquired by the information acquirer 20 (Step S303).

In some embodiments, the acceleration processor 12 may determine whether the detector 11 has detected, based on the image data on the area ahead of the vehicle acquired by the information acquirer 20, the crest area of the short-distance road, such as an overbridge, and whether the distance from a current position (the point P4 in FIG. 12) of the vehicle to the crest area of the short-distance road, such as an overbridge, is equal to a predetermined distance, that is, whether the current position of the vehicle is a point at which the control is to start.

In addition, the vehicle speed processor 13B may determine whether the detector 11 has detected whether the vehicle has reached the gentle upward-gradient region of the short-distance road, such as an overbridge, that is, whether the vehicle has reached the point at which the control is to start, based on the traveling environment information acquired by the information acquirer 20.

In some embodiments, the vehicle speed processor 13B may determine whether the detector 11 has detected the crest area of the short-distance road such as an overbridge, based on the image data on the area ahead of the vehicle acquired from the information acquirer 20.

If the acceleration processor 12 determines that the detector 11 has not detected the gentle upward-gradient region of the short-distance road, such as an overbridge, based on the traveling environment information acquired by the information acquirer 20 (Step S303: NO), the process may shift to the standby-mode.

If the acceleration processor 12 determines that the detector 11 has detected the gentle upward-gradient region of the short-distance road, such as an overbridge, based on the traveling environment information acquired by the information acquirer 20 (Step S303: YES), the vehicle speed processor 13B may perform the control of clearing the integral term of the AFB offset (Step S304).

In addition, if the vehicle speed processor 13B determines that the detector 11 has detected the crest area of the short-distance road, such as an overbridge, based on the image data on the area ahead of the vehicle acquired from the information acquirer 20, the vehicle speed processor 13B may perform the control of decreasing the primary delay time constant, in accordance with the distance to the crest area of the short-distance road, such as an overbridge (Step S305).

Since the AFB offset value is cleared and the primary delay time constant is decreased by the two kinds of control described above, the vehicle speed of the vehicle may be decreased from about 52 km/h set at the point P4 in FIG. 12 to the set vehicle speed (e.g., 50 km/h) at a point P5 in FIG. 12, for example.

Thereafter, at a point 5A in FIG. 12, the vehicle may reach the gentle upward-gradient region near the crest area of the uphill slope, and the primary delay time constant may be decreased. The vehicle speed may thus be maintained at 50 km/h.

After the vehicle starts traveling on the uphill slope, the acceleration processor 12 may determine whether the target acceleration rate is 0 [m/s²] (Step S306).

If the acceleration processor 12 determines that the target acceleration rate is not 0 [m/s²] (Step S306: NO), the process may shift to the stand-by mode.

If the acceleration processor 12 determines that the target acceleration rate is 0 [m/s²] (Step S306: YES), the vehicle speed processor 13B may perform the control of clearing the integral term of the AFB offset control (Step S304).

In this case also, the vehicle speed of the vehicle may be decreased from 52 km/h set at the point P4 in FIGS. 12 to 50 km/h at the point P5 in FIG. 12, for example. At a point P6 in FIG. 12, the vehicle speed may be increased to 50.5 km/h due to an influence of a downward gradient; however, the AFB offset value may be set at a negative value to prevent the vehicle speed from increasing excessively.

Thereafter, at a point P6A in FIG. 12, the vehicle speed may be decreased by the AFB offset value set at the negative value, and thereafter the AFB offset value may be cleared.

Thereafter, the vehicle speed processor 13B may determine whether a predetermined time has elapsed after the vehicle has reached the crest area of the short-distance road, such as an overbridge, that is, whether the vehicle has reached the point at which the control is to end (Step S307).

If the vehicle speed processor 13B determines that the vehicle has not yet reached the point at which the control is to end (Step S307: NO), the process may shift to the stand-by mode.

If the vehicle speed processor 13B determines that the vehicle has reached the point at which the control is to end (Step S307: YES), the primary delay time constant may be returned to an initial value (Step S308).

If it is determined by the detector 11 that the vehicle has finished traveling on the downhill slope, based on the image data on the area ahead of the vehicle acquired by the information acquirer 20 (Step S309), the vehicle speed processor 13B may end the process while continuing the traveling under the ACC (Step S310).

### <Workings and Effects>

As described above, the vehicle speed processor 13B of the traveling control apparatus 1B according to the present example embodiment may be configured to perform the control of clearing the component of the integral control performed by the acceleration processor 12, in the gentle upward-gradient region of the short-distance road, or perform the control of clearing the component of the integral control performed by the acceleration processor 12 when the difference between the acceleration rate of the vehicle and the target acceleration rate becomes less than or equal to zero. In addition, the vehicle speed processor 13B may perform the control of sequentially decreasing the value of the primary delay time constant used at the estimator 14, as the gradient of the short-distance road becomes gentler, in the gentle upward-gradient region of the short-distance road.

That is, when a predetermined condition is satisfied, the vehicle speed processor 13B may perform the control of clearing the component of the integral control performed by the acceleration processor 12 and the control of sequentially decreasing the value of the primary delay time constant used at the estimator 14.

For example, when the vehicle reaches the point at which the control is to start while traveling on the uphill slope, the vehicle speed of the vehicle is suppressed from increasing excessively in the crest area of the short-distance road by the vehicle speed processor 13B performing the control of clearing the component of the integral control performed by the acceleration processor 12 and the control of sequentially decreasing the value of the primary delay time constant used at the estimator 14.

It is therefore possible to achieve safety travel without arousing an unwanted feeling of fear of the occupant of the vehicle during traveling on the uphill slope.

In some embodiments, a program that causes the process to be performed by the traveling ECU 10, 10A, or 10B may be recorded on a non-transitory recording medium readable by a computer system. The traveling control apparatus 1, 1A, or 1B according to the example embodiments of the disclosure may be implemented by causing a memory of the computer system to load the program recorded in the non-transitory recording medium and causing the computer system to perform the program. The “computer system” as used herein may encompass an operating system (OS) and hardware such as a peripheral device.

The “computer system” may encompass a website providing environment or a website displaying environment, when the computer system utilizes a World Wide Web (WWW) system. The program may be transmitted from the computer system that contains the program in a device such as a storage device to another computer system via a transmission medium or by a carrier wave in a transmission medium. The “transmission medium” designed to transmit the program may refer to a medium having a capability to transmit data, including: a network or a communication network such as the Internet; and a communication link or a communication line such as a telephone line.

The program may be directed to implement a part of the process to be performed by the traveling ECU 10, 10A, or 10B described above. The program may be a so-called differential file or differential program designed to implement the process to be performed by the traveling ECU 10, 10A or 10B described above by a combination of the program already recorded on the computer system.

Although some embodiments of the disclosure have been described in the foregoing by way of example with reference to the accompanying drawings, the disclosure is by no means limited to the embodiments described above. It should be appreciated that modifications and alterations may be made based on the traveling control apparatuses 1, 1A, and 1B described above as the example embodiments of the disclosure by the persons skilled in the art without departing from the scope as defined by the appended claims. The disclosure is intended to include such traveling control apparatuses according to the modifications and alterations in so far as they fall within the scope of the appended claims or the equivalents thereof.

It is understood that the persons skilled in the art can conceive of various modifications and variations within the scope of the disclosure and that these modifications and variations also fall within the scope of the disclosure.

For example, a modification to which some elements are added by the persons skilled in the art, a modification from which some elements are deleted by the persons skilled in the art, a modification the elements of which are changed in design by the persons skilled in the art, a modification to which some steps are added by the persons skilled, a modification from which some steps are deleted by the persons skilled in the art delete, and a modification the conditions of which are changed by the persons skilled in the art also fall within the scope of the disclosure as long as these modifications are in accordance with the gist of the disclosure.

Further, it should be understood that other effects apparently obtainable by the aspects of the disclosure described herein or other effects appropriately conceivable by the persons skilled in the art are provided by the disclosure.

Various other example embodiments are obtainable by appropriately combining the elements disclosed herein.

For example, some elements may be deleted from all the elements described in the example embodiments.

Further, the elements in different example embodiments may be combined as appropriate.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term “substantially”, “approximately”, “about”, and its variants having a similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

One or more of the information acquirer 20, the detector 11, and the vehicle speed processors 13, 13A, and 13B illustrated in FIGS. 1, 2, 5, 6, 9, and 10 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the information acquirer 20, the detector 11, and the vehicle speed processors 13, 13A, and 13B illustrated in FIGS. 1, 2, 5, 6, 9, and 10. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the information acquirer 20, the detector 11, and the vehicle speed processors 13, 13A, and 13B illustrated in FIGS. 1, 2, 5, 6, 9, and 10.

1. A traveling control apparatus configured to be applied to a vehicle, the traveling control apparatus comprising:
an information acquirer configured to acquire traveling environment information on a surrounding environment around the vehicle, the surrounding environment comprising an area ahead of the vehicle;
a detector configured to detect a gentle upward-gradient region of a short-distance road, based on the traveling environment information acquired by the information acquirer; and
a vehicle speed processor configured to suppress, in the gentle upward-gradient region of the short-distance road, unnecessary acceleration and deceleration of the vehicle caused based on an integrated value of a deviation between an acceleration rate of the vehicle and a target acceleration rate.

2. The traveling control apparatus according to claim 1, further comprising
an acceleration processor configured to control the acceleration rate of the vehicle by performing integral control that is based on the integrated value of the deviation between the acceleration rate of the vehicle and the target acceleration rate, wherein
the vehicle speed processor is configured to perform control of clearing a component of the integral control performed by the acceleration processor, in the gentle upward-gradient region of the short-distance road.

3. The traveling control apparatus according to claim 2, wherein the gentle upward-gradient region is defined in accordance with a distance from the vehicle to a crest area of the short-distance road, the distance being acquired by the information acquirer.

4. The traveling control apparatus according to claim 1, further comprising:
an acceleration processor configured to control the acceleration rate of the vehicle by performing integral control that is based on the integrated value of the deviation between the acceleration rate of the vehicle and the target acceleration rate, wherein,
the vehicle speed processor is configured to, when a difference between the acceleration rate of the vehicle and the target acceleration rate becomes less than or equal to zero, perform control of clearing a component of the integral control performed by the acceleration processor.

5. The traveling control apparatus according to claim 1, further comprising:
an estimator configured to estimate an upward gradient of the short-distance road by performing filter processing of sensor outputs from acceleration sensors respectively disposed on front and rear portions of the vehicle, using a primary delay time constant, wherein
the vehicle speed processor is configured to sequentially decrease a value of the primary delay time constant in accordance with the distance from the vehicle to the crest area of the short-distance road, in the gentle upward-gradient region of the short-distance road.

6. The traveling control apparatus according to claim 2, further comprising:
an estimator configured to estimate an upward gradient of the short-distance road by performing filter processing of sensor outputs from acceleration sensors respectively disposed on front and rear portions of the vehicle, using a primary delay time constant, wherein
the vehicle speed processor is configured to sequentially decrease a value of the primary delay time constant in accordance with the distance from the vehicle to the crest area of the short-distance road, in the gentle upward-gradient region of the short-distance road.

7. The traveling control apparatus according to claim 3, further comprising:
an estimator configured to estimate an upward gradient of the short-distance road by performing filter processing of sensor outputs from acceleration sensors respectively disposed on front and rear portions of the vehicle, using a primary delay time constant, wherein
the vehicle speed processor is configured to sequentially decrease a value of the primary delay time constant in accordance with the distance from the vehicle to the crest area of the short-distance road, in the gentle upward-gradient region of the short-distance road.

8. The traveling control apparatus according to claim 4, further comprising:
an estimator configured to estimate an upward gradient of the short-distance road by performing filter processing of sensor outputs from acceleration sensors respectively disposed on front and rear portions of the vehicle, using a primary delay time constant, wherein
the vehicle speed processor is configured to sequentially decrease a value of the primary delay time constant in accordance with the distance from the vehicle to the crest area of the short-distance road, in the gentle upward-gradient region of the short-distance road.

9. A traveling control apparatus configured to be applied to a vehicle, the traveling control apparatus comprising circuitry configured to
acquire traveling environment information on a surrounding environment around the vehicle, the surrounding environment comprising an area ahead of the vehicle;
detect a gentle upward-gradient region of a short-distance road, based on the traveling environment information, and
suppress, in the gentle upward-gradient region of the short-distance road, unnecessary acceleration and deceleration of the vehicle caused based on an integrated value of a deviation between an acceleration rate of the vehicle and a target acceleration rate.
